(19) United States
(12) Patent Application Publication
(10) Pub. No.: US 2013/0067974 A1
(43) Pub. Date: Mar. 21, 2013

(54) INTEGRATED METHOD OF BIOLOGICAL VALORIZATION OF ORGANIC WASTE IN AN AGRICULTURAL ENVIRONMENT

(71) Applicant: Michel Dufour, Notre-Dame-de-I'lle-Perrot (CA)

(72) Inventor: Michel Dufour, Notre-Dame-de-I'lle-Perrot (CA)

(21) Appl. No.: 13/700,377

(22) PCT Filed: May 27, 2011
(86) PCT No.: PCT/CA2011/000629

§ 371 Date: Nov. 27, 2012

Related U.S. Application Data
(60) Provisional application No. 61/348,815, filed on May 27, 2010.

(51) Int. Cl. C05F 9/04

(52) U.S. Cl. CPC C05F 9/04
USPC 71/14; 71/11; 71/23

(57) ABSTRACT

There is provided an integrated method of composting compostable organic waste matter by macerating compostable organic waste matter with a structuring agent and mixing additional compostable organic waste matter and/or structuring agent in the composting mixture. There is also provided an integrated method of biological valorization of compostable organic waste matter for composting by collecting in a coordinated manner a compostable organic waste matter from waste matter generator and delivering in a coordinated manner the collected compostable organic waste matter to a composting site.

### BACKGROUND

(a) Field

The subject matter disclosed generally relates to integrated methods of composting compostable organic waste matter or to integrated methods of managing compostable organic waste matter for composting.

(b) Related Prior Art

Composting of compostable organic matter has been and remains a relatively current practice in agriculture. Moreover, industrial composting platforms have been put into function in many industrialized countries. The large scale platforms are nevertheless relatively rare, and are generally located far from urban centers where the compostable organic matter is mainly produced. These centers are often ill perceived by the population who considers that their activity is detrimental to their quality of life because of strong odors, and harmful to the environment because of soil and the under lying water table.

Interestingly, implantation of smaller scale composting plants for the development of compostable organic matter from agricultural, food and grocery sources has remained largely unexploited mainly because of the absence of logistical support for the collection, sorting, and transport of the compostable organic matter to nearby sites carrying out composting activities.

Therefore, there is a need for integrated methods of composting compostable organic matter from agricultural, food and grocery sources.

Also, there is a need for integrated methods of managing the integrated composting from compostable organic waste matter from agricultural, food and grocery sources.

### SUMMARY

In a first embodiment there is disclosed an integrated method of composting compostable organic waste matter comprising:
a) macerating a composting mixture of compostable organic waste matter with a structuring agent in a composting compartment for a period of time sufficient for endogenous microorganisms to effect biodegradation; and
b) mixing additional compostable organic waste matter and/or structuring agent in said composting mixture of step a), wherein when said composting compartment is full, at least part of said composting mixture is transferred to a maturation compartment to further macerate and produce a compost for use as a fertilizer,
wherein said composting compartment comprises a leachate retaining base preventing draining of leachate into a surrounding soil, and is connected to a reservoir for collecting said leachate,
wherein said leachate is reinjected into said composting mixture and said composting mixture is exposed to an evaporator to evaporate said leachate from said composting mixture.

The least one injector may reinject the leachate into the composting mixture.

The leachate may be uniformly reinjected into the composting mixture.

The evaporator may be chosen from a ventilation system, a heating system, or combinations thereof.

The ventilation system may be chosen from a negative ventilation system, a positive ventilation system, or combinations thereof.

The leachate may be reinjected when the composting mixture has reached a temperature from about 60° C. to 72° C.

The leachate may be reinjected when the composting mixture has reached a density from about 650 g/L to about 750 g/L.

The compostable organic waste matter may comprise food waste.

The compostable organic waste matter may comprise vegetal matter, vegetable matter, fruit matter, bakery matter, or combinations thereof.

The structuring agent may comprise sawdust, straw, peat, grass, jute, cardboard, corn cob granules, bark chips, woodchips, wood particles, manure or combinations thereof.

The leachate retaining base may be made from concrete.

The leachate retaining base may be made from a plastic polymer.

The initial ratio of the volume of organic waste matter to the volume of structuring agent may be from about 1.5:1 to about 3:1, or from about 2:1.5 to about 3:1.5.

The compostable organic waste matter in step a) may be about 57% of the total initial volume of the composting mixture.

The structuring agent in step a) may be about 43% of the total initial volume of the composting mixture.

In the method according to the present invention, when additional compostable organic waste matter and structuring agent may be added in the composting mixture of step a), the ratio of compostable organic waste matter to structuring agent may be from about 3:1 to about 6:1.

The mixing additional compostable organic waste matter of step b) may be performed once a week.

In a second embodiment there is disclosed an integrated method of biological valorization of compostable organic waste matter for composting comprising:
a) collecting in a coordinated manner a compostable organic waste matter from at least one waste matter generator; and
b) delivering in a coordinated manner the collected compostable organic waste matter to at least one composting site;
wherein the coordinated manner is based on a schedule and a geographical route between the waste matter generator and the composting site; and
wherein quality of the compostable organic waste matter is verified at the waste matter generator and at the composting site to prevent contamination of the organic waste matter with a non-compostable waste matter.

The method may further comprise in step a) weighing the compostable organic waste matter concurrently to the collecting.

The method may further comprise in step b) weighing the compostable organic waste matter concurrently to said delivering.

The method may further comprise in step a) sorting the compostable organic waste matter from a non-compostable waste matter.

The sorting may be performed by the waste matter generator.

The method may further comprise providing training to an employee of the waste matter generator for sorting of the compostable organic waste matter from said non-compostable waste matter.

The method may further comprise providing an equipment for sorting of compostable organic waste matter from the non-compostable waste matter.

The method may further comprise preparing composting bed in a composting compartment at the composting site prior to delivery of the compostable organic waste matter to said composting site.

The organic waste matter may be delivered directly into a composting compartment at said composting site.

The method may further comprise composting the compostable organic waste matter delivered at the composting site by
a) macerating a composting mixture of compostable organic waste matter with a structuring agent in a composting compartment for a period of time sufficient for endogenous microorganisms to effect biodegradation; and
b) mixing additional compostable organic waste matter and/or structuring agent in the composting mixture of step a),
   wherein when the composting compartment is full, at least part of the composting mixture is transferred to a maturation, compartment to further macerate and produce a compost for use as a fertilizer,
   wherein the composting compartment comprises a leachate retaining base preventing draining of leachate into a surrounding soil, and is connected to a reservoir for collecting said leachate,
   wherein said leachate is reinjected into said composting mixture and said composting mixture is exposed to an evaporator to evaporate said leachate from said composting mixture.

The at least one injector may reinjects the leachate into the composting mixture.

The leachate may be uniformly reinjected into the composting mixture.

The evaporator may be chosen from a ventilation system, a heating system, or combinations thereof.

The ventilation system may be chosen from a negative ventilation system, a positive ventilation system, or combinations thereof.

The leachate may be reinjected when the composting mixture has reached a temperature from about 60° C. to 72° C.

The leachate may be reinjected when the composting mixture has reached a density from about 650 g/L to about 750 g/L.

The initial ratio of the volume of organic waste matter to the volume of structuring agent may be from about 1.5:1 to about 3:1, or from about 2:1.5 to about 3:1.5.

The compostable organic waste matter in step a) may be about 57% of the total initial volume of the composting mixture.

The structuring agent in step a) may be about 43% of the total initial volume of the composting mixture.

In the method of the present invention, when additional compostable organic waste matter and structuring agent may be added in the composting mixture of step a), the ratio of the compostable organic waste matter to the structuring agent may be from about 3:1 to about 6:1.

The preparing may comprise mixing and distributing the composting mixture in the composting compartment to prepare the composting bed.

The method may further comprise providing training to an employee of the composting site for performing a method of composting.

The compostable organic waste matter may comprise food waste.

The compostable organic waste matter may comprise vegetal matter, vegetable matter, fruit matter, bakery matter, or combinations thereof.

The structuring agent may comprise sawdust, straw, peat, grass, jute, cardboard, corn cob granules, bark chips, woodchips, wood particles, manure or combinations thereof.

The leachate retaining base may be made from concrete.

The leachate retaining base may be made from a plastic polymer.

The schedule may include a collection once a week.

The method may further comprise visiting the waste matter generator for controlling the quality of the compostable organic waste matter.

The method may further comprise visiting the composting site for controlling the quality of the composting mixture.

The method further comprise providing technical support for performing a method of composting according to the present invention.

The following terms are defined below.

The term “leachate” is intended to mean the liquid that drains or ‘leaches’ from a landfill or composting mixtures; it varies widely in composition regarding the age of the landfill or compost and the type of waste that it contains. It can usually contain both dissolved and suspended material.

The term “waste matter generator” is intended to mean any entity that generates compostable and non-compostable waste matter that may be sorted on site according to the method of the present invention. Waste matter generator include grocery stores, indoor or outdoor markets, sites of food preparation and/or transformation such as industrial bakeries, agrifood factories, and even a factory generating compostable organic waste matter.

The term “active composting mixture” is intended to mean the composting mixture that is being degraded in the composting platform. The active composting mixture acts as inoculants and favors further composting.

The term “structuring agent” is intended to mean a material capable of increasing the porosity of the material being composted so that an optimal porosity may be obtained for the composting process. These materials may be absorbent, they may be of vegetal origin, they may be biodegradable or non-biodegradable. When non-biodegradable materials are used, they may be removed from the compost, for example by sieving the compost, before it is used.

The term “macerating” is intended to mean the degradation, breaking or softening into smaller pieces of the compostable organic waste matter during the composting process.

The term “maturation” is intended to mean the step of the composting process when the composting mixture is allowed to age and become a usable compost for any agricultural purpose.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

FIG. 1 illustrates a composting cell comprising composting compartment according to one embodiment of the present invention.

FIG. 2 illustrates a method of managing compostable organic waste matter according to one embodiment of the present invention.

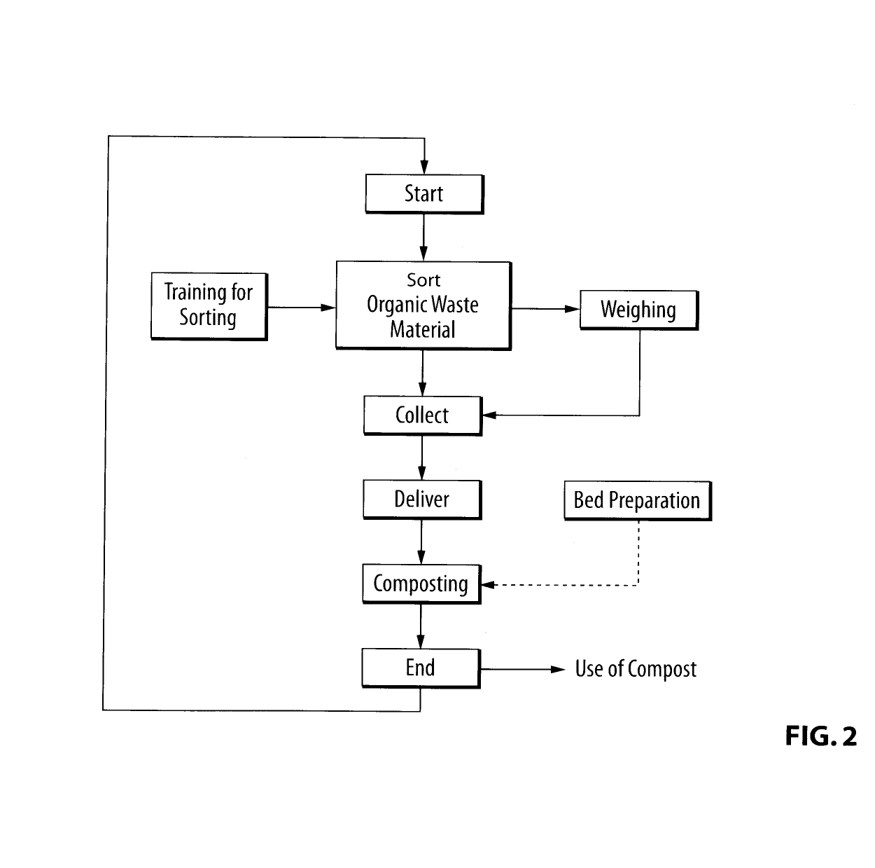

FIG. 3. Illustrates a reservoir for use with a composting compartment according to one embodiment of the present invention.

FIG. 4 illustrates a ventilator for use with a composting compartment according to one embodiment of the present invention.

FIG. 5 illustrates a composting compartment according to one embodiment of the present invention.

FIG. 6 illustrates an injector according to one embodiment of the present invention.

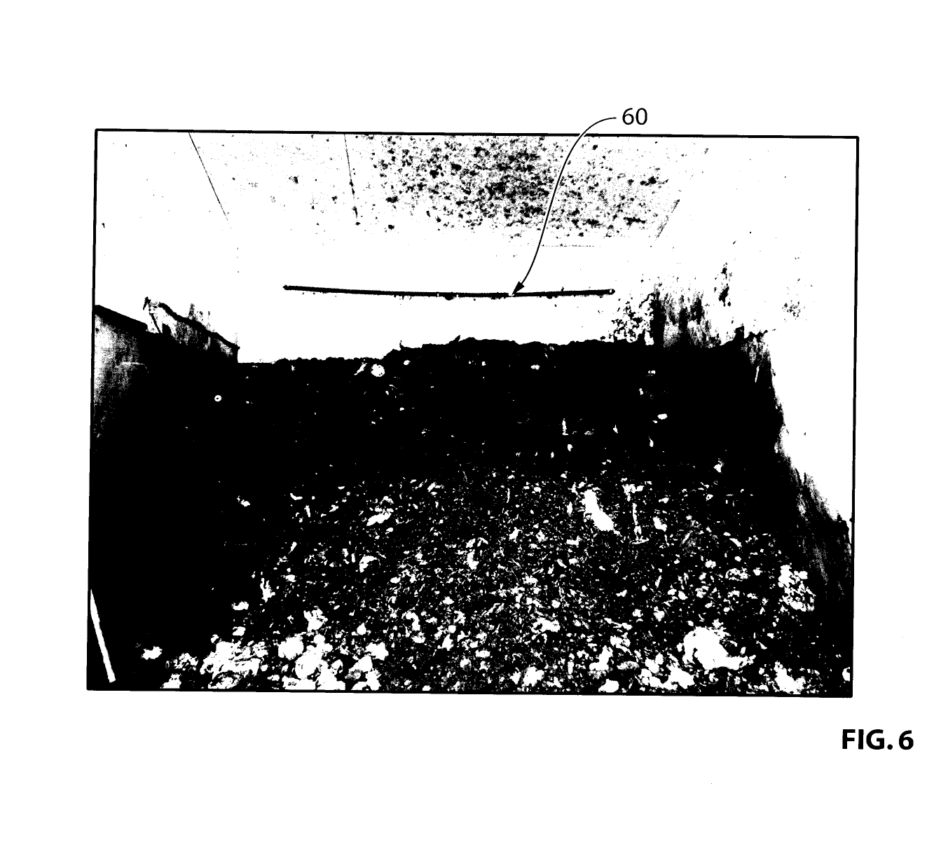

FIG. 7 illustrates a housekeeping pad according to one embodiment of the present invention.

FIG. 8 illustrates a composting cell comprising composting compartment according to one embodiment of the present invention.

FIG. 9 illustrates a composting cell comprising ventilators according to one embodiment of the present invention.

### DETAILED DESCRIPTION OF THE PREFERRED EMBODIMENTS

The present invention relates to an integrated method of composting compostable organic waste matter. The basic principle of this method is the introduction of structuring agent at the onset of composting, to provide structure to the composting mixture to obtain an optimal porosity for composting. The structuring agent may be an absorbent, and it may be of vegetal origin (i.e. of carbonic origin). The structuring agent may be a compostable (a biodegradable material). The structuring agent may be a material that is not biodegradable. When non biodegradable material is introduce into the composting mixture, it must be removed from the compost (e.g. by sieving the compost) before it is used. The compostable organic waste matter and the structuring agent may be mixed when new additional compostable organic waste matter is introduced to the original mixture. According to some embodiments, the structuring agent mixed with compostable organic waste matter may effectively be composted with the compostable organic waste matter. The compost generated therefrom may eventually become an absorbent, which may be used to reinforce the structuring agent introduced at the onset of the composting activity. According to one embodiment of the present invention, the amount of structuring agent that is employed is maintained to a minimum in order to reduce to a minimum the volume to be composted. This diminution of volume to be composted allows to reduce the cost of the composting operation because of the mass to be manipulated are considerably reduced. Also, a further cost reduction is also gained by the reduction in the amount of structuring agent required for the composting operation. The absorbing capacity of the composting mixture will increase as the volume of compost generated increases, as the compost generated from the method of the present invention has an important absorbing potential. Additional structuring agent may be added at some point during the composting according to the porosity of the composting mixture.

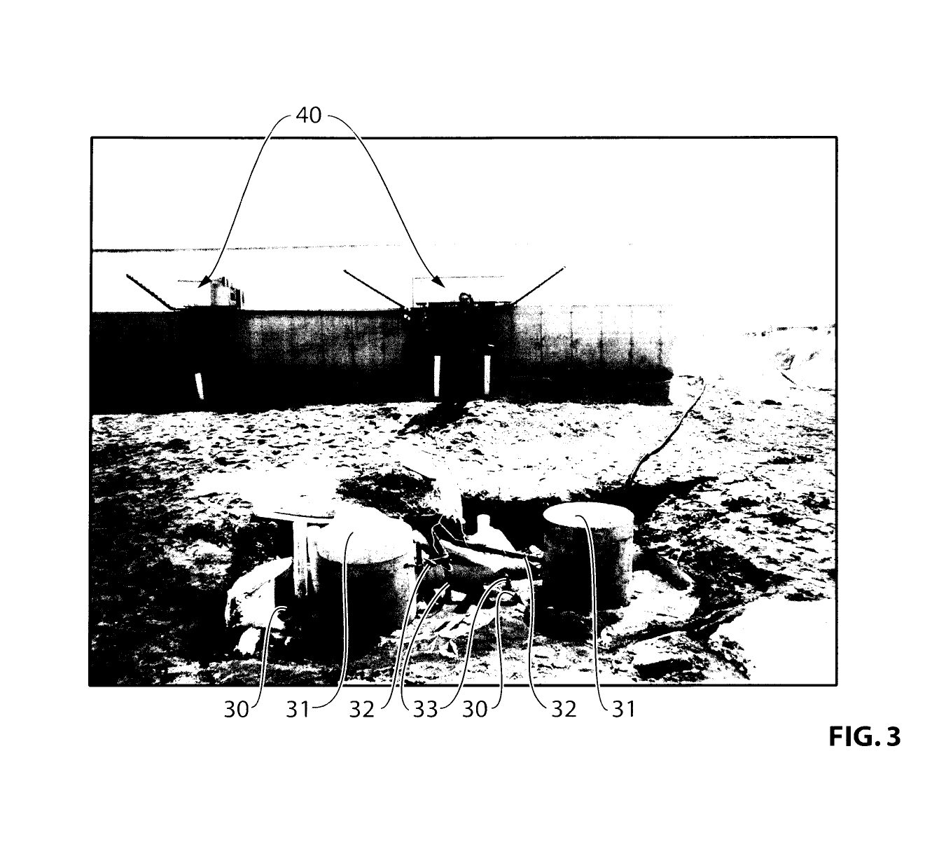

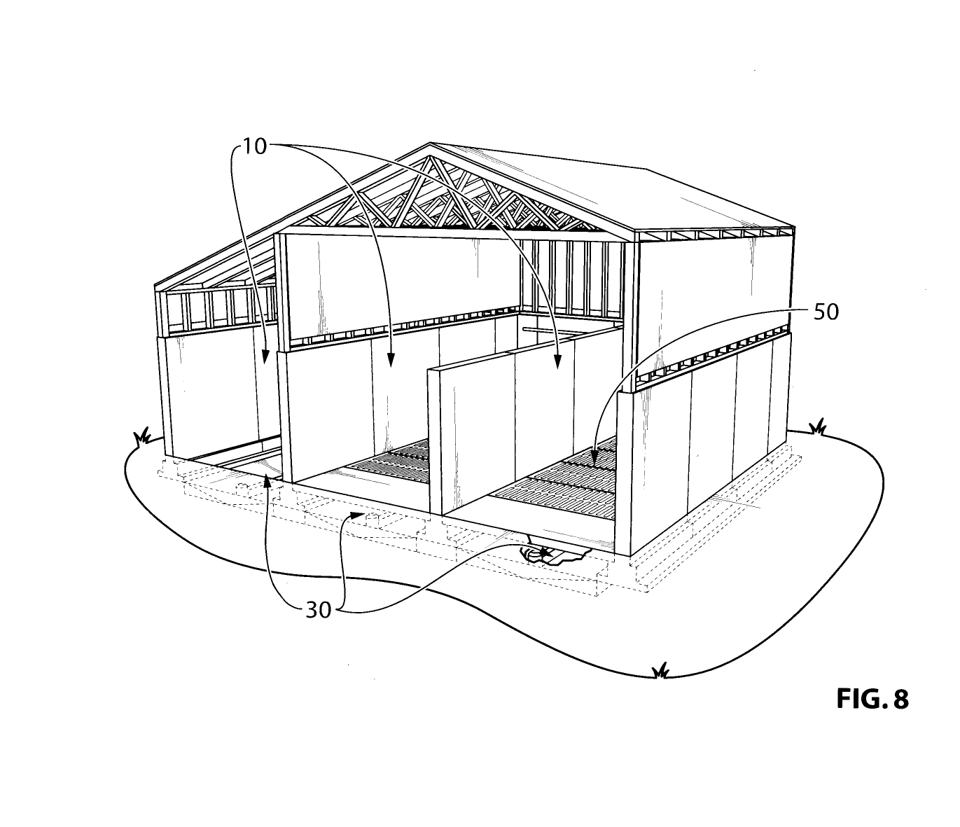

The integrated method of composting of the present invention is performed on a platform adapted to contain the leachate (i.e. liquid residues) generated from the composting of the organic waste matter. Containing the liquids allows the absorption and evaporation to exercise its action on the compostable waste matter, as well as prevents any potential contamination of the surrounding soil and subterranean water or wells present near the composting site. According to an embodiment, a minimal amount of structuring agent is used with the compostable organic waste matter to allow the flow of leachate to an attendant reservoir 30. Therefore, the plateform may also be connected to an attendant reservoir 30 for collecting the leachate, such as a tank, or an artificial basin. Now referring to FIGS. 3 and 8, reservoirs 30 according to embodiments of the present invention are shown. In FIG. 3 the reservoirs are covered by manhole 31, and the leachate enter the reservoir through inlet 32 and is pumped to be injected through outlet 33. In FIG. 8, according to another embodiment of the present invention, the leachate may drain from grille 50, through which blown air will also enter the composting mixture. The leachate thereby collected may be progressively reinjected into the composting mixture once the composting mixture has sufficiently increased in temperature (e.g. 60° C. to 72° C.) and/or dried (e.g. reached a density of less than 750 g/L, and preferably of about 650 g/L to about 750 g/L), such that it may be progressively reinjected and evaporated. Preferably, the leachate is reinjected uniformly in the composting mixture. Preferably, the leachate is reinjected over the composting mixture by at least one injector 60 that may be disposed over the composting mixture, to favor a uniform distribution of the leachate. The leachate may be reinjected over or in the composting mixture according to a predetermined schedule. For example, according to an embodiment, every 30 minutes a 15 seconds injection, at 1.8 L/sec may be performed. The injector 60 may be in fluid communication with the reservoir 30 from which the leachate is pumped.

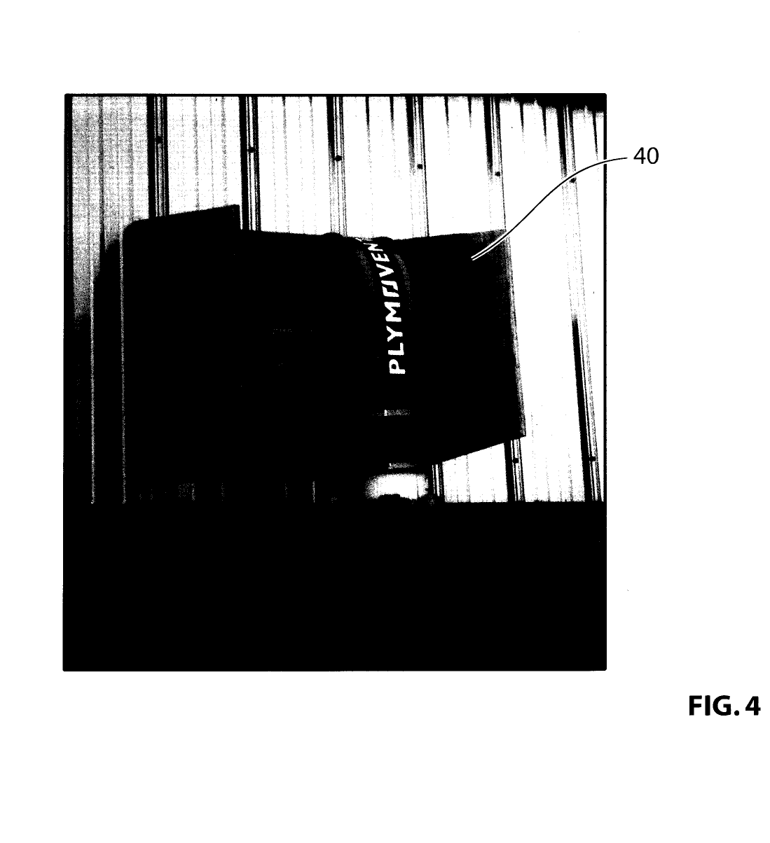

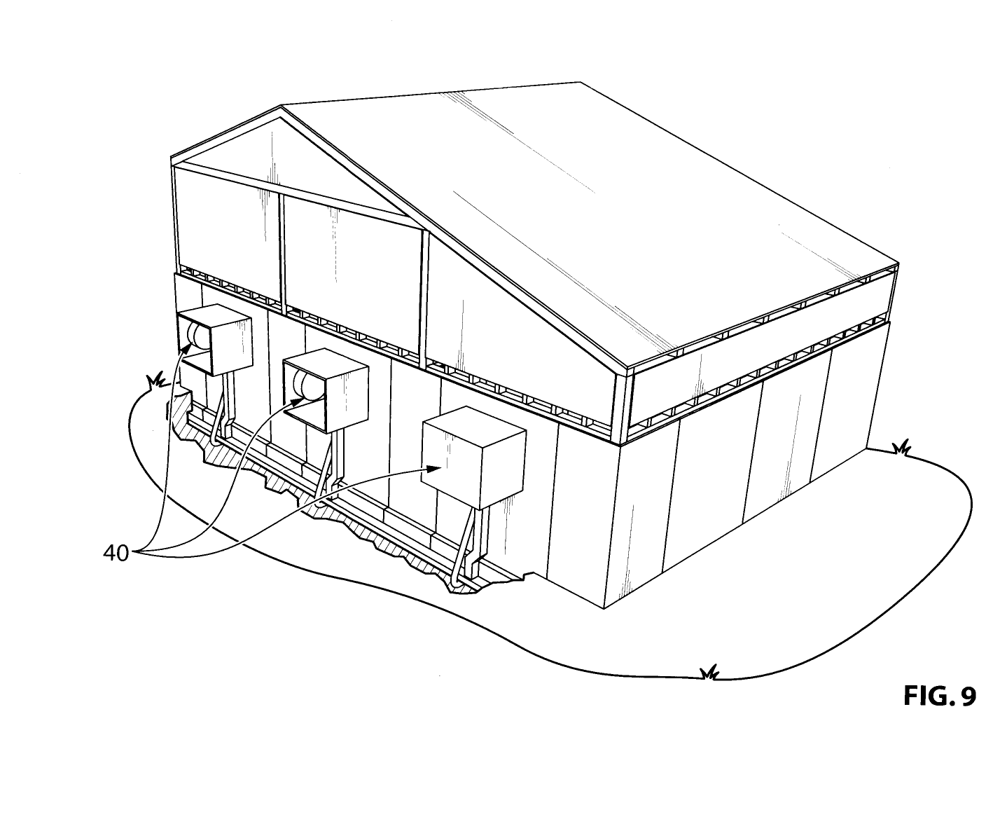

According to one embodiment of the present invention, the composting mixture may be exposed to an evaporator to optimize the evaporation of the leachate. Any suitable system that favors the evaporation of liquid may be used, such as ventilation systems (positive or negative, or their combination) or heating systems, or their combination, may be used. Preferably, the evaporator may be a ventilation system which permits the forced aeration of the composting mixture to increase the evaporation potential of the composting mixture as well as accelerate the composting process. Now referring to FIG. 4 or 9. The ventilation system may be for example one or more ventilators 40 capable of maximal output of about 1200 cubic feet/minute (ft³/min) of air. The air pushed by the ventilator 40 may be introduced into the composting mixture through a ventilation grille 50, which may be, for example at the bottom of the composting platform 10 and may be removable. For example, the ventilators 40 may exert an optimal pressure from about 1 in of water to about 6 inches of water (corresponding to about 100 ft³/min to about 600 ft³/min) on the composting mixture. According to an embodiment of the present invention, the porosity of the composting mixture is considered to be good at about 100 ft³/min (1 inch of water). According to another embodiment of the present invention, the porosity of the composting mixture is considered deficient at about 600 ft³/min (6 inches of water) and the porosity of the composting mixture may be improved with the addition of structuring agent. Overventillation of the composting mixture is not desirable and may result, for example, in net loss in the nitrogen content of the composting mixture.

The method of the present invention allows for the composting of relatively important quantities of compostable waste matter in restricted volumes, while efficiently managing the leachate that this composting activity generates. Therefore, instead of managing a volume of 3000 cubic meters (m³) of compost, a person composting will be able to compost 1000 to 1200 metric ton (tm) a year of compostable waste matter in about 150 cubic meter (m³) of usable space for composting, over the course of a year, with a continuous and regular flow of organic waste matter being introduced in the composting mixture through regular and continuous arrivals of organic waste matter. This allows for important savings on the cost of labor, on the cost of the acquisition and management of important volumes of organic matter, while maintaining a very environmentally secure operation during any season of the year.

Furthermore, the rapid integration of new compostable waste matter from each collections, that are treated immediately upon arrival at the site of composting, combined with the frequent mixing of the composting mixture allow for a very low production of methane, and an optimal management of the odors at and near the site of composting.

The compostable organic waste matter that may be used in the method of the present invention may be without limitations any food waste sorted on source. For example, this includes without limitations vegetal matter (e.g. cut flowers, or any other plant matter), vegetable matter, fruit matter, bakery matter, such as bread, pastries, cakes, or any other baked products that were not sold and went passed their due date. Food waste other than fruits and vegetables may be composted with the method of the present invention. However, because these residual products attract pests (e.g. rats, mice, and other vermin) to the site of composting, additional infrastructure (e.g. fencing, wiring, walls, or any suitable means of keeping vermin away) would be required to protect the composting mixtures. Furthermore, when composting meat, poultry and fish residual products, the composting infrastructure is kept relatively far away from human habitats because of potential unpleasant odors caused by the inadequate composting of such matter. At the onset of the composting activity, the compostable organic waste matter and the structuring agent are mixed together. The ratio of compostable organic waste matter and the structuring agent may vary according to the type of compostable organic waste matter being treated and will need to be adjusted in order to obtain a composting mixture with an optimal porosity. For example, a composting mixture with a porosity of about 100 ft³/min is considered adequate. According to some embodiments, the ratio of compostable organic waste matter and the structuring agent may be from about 1.5 volume compostable organic waste matter to about 1 volume of structuring agent to about 3 volume compostable organic waste matter to 1 volume of structuring agent, or from about 2:1 to about 3:1 or from about 2.5:1 to about 3:1, or from about 2:1.5 to about 3:1.5, or from about 2.5:1.5 to about 3:1.5. According to a preferred embodiment, 2 volumes of compostable organic waste matter are mixed with about 1.5 volumes of structuring agent. Therefore the compostable organic waste matter is about 57% of the total initial volume of the composting mixture, and the structuring agent represents about 43% of the total initial volume of the composting mixture. According to another embodiment of the present invention, at the onset of the composting activity, compostable organic waste matter may be mixed with a portion of inoculants, such as active compost, along with structuring agent. The addition of inoculants allows for a faster onset of the composing reaction through the addition of live microorganisms therein. A ratio of compostable waste matter to inoculants to structuring agent of about 1:1:1.5 is suitable for initiating such composting mixture.

The structuring agent that may be used in the method of the present invention includes sawdust, straw, peat, grass, jute, cardboard, corn cob granules, bark chips, woodchips, wood particles, manure (e.g. horse, cattle, pig, sheep, chicken, turkey, rabbit, etc). Also, the structuring agent may be made from non biodegradable material such as plastic, rubber, metal, rock, or any other suitable material. For example, they may be pieces of used tires that have been shredded. At the onset of the composting activity the volume of structuring agent in the total initial volume of the composting mixture, may be for example about 43% of the total initial volume of the composting mixture. On the first week of composting, 2 volumes of compostable organic waste matter and 1.5 volumes of structuring agent may be mixed. On the second and subsequent weeks, the ratio of compostable organic waste matter to structuring agent that may be added to the volume of composting mixture may be from about 3:1 to about 6:1, or from about 3.5:1 to about 6:1, or from about 4:1 to about 6:1, or from about 4.5:1 to about 6:1, or from about 5:1 to about 6:1, or from about 5.5:1 to about 6:1. The second (and subsequent) addition of compostable organic waste matter causes the structuring agent to be extremely solicitated. The volume of structuring agent introduced into the composting mixture remains relatively stable for the duration of the method of the present invention (e.g. ratios of about 6:1 to about 3:1 of compostable organic waste matter over structuring agent).

During the 6^{th}, 7^{th} or 8^{th} week of composting, or depending on the available composting spaces, a part of the composting mixture will need to be transferred to a different compartment for maturation (a maturation compartment). A minimum of 2 weeks of composting is necessary before transferring the composting mixture. No further additional compostable organic waste matter will be added at the maturation stage. However, should the maturation temperatures be over 60° C., and preferably from about 60° C. to about 72° C., the composting mixture may be injected with leachate in order to use the evaporation potential of this volume of composting mixture. During the maturating phase, when the temperature decreases below 55° C., the injection of leachate should be stopped. A maturation period of 35 to 42 days is usually necessary to obtain a complete maturation of the composting mixture.

The method of the present invention allows from about 3.0 to about 6 volumes of organic waste matter to be composted in the presence of 1 volume of structuring agent. It is therefore possible to compost between about 80 m³ to about 120 m³ of organic matter for each 20 m³ of structuring agent.

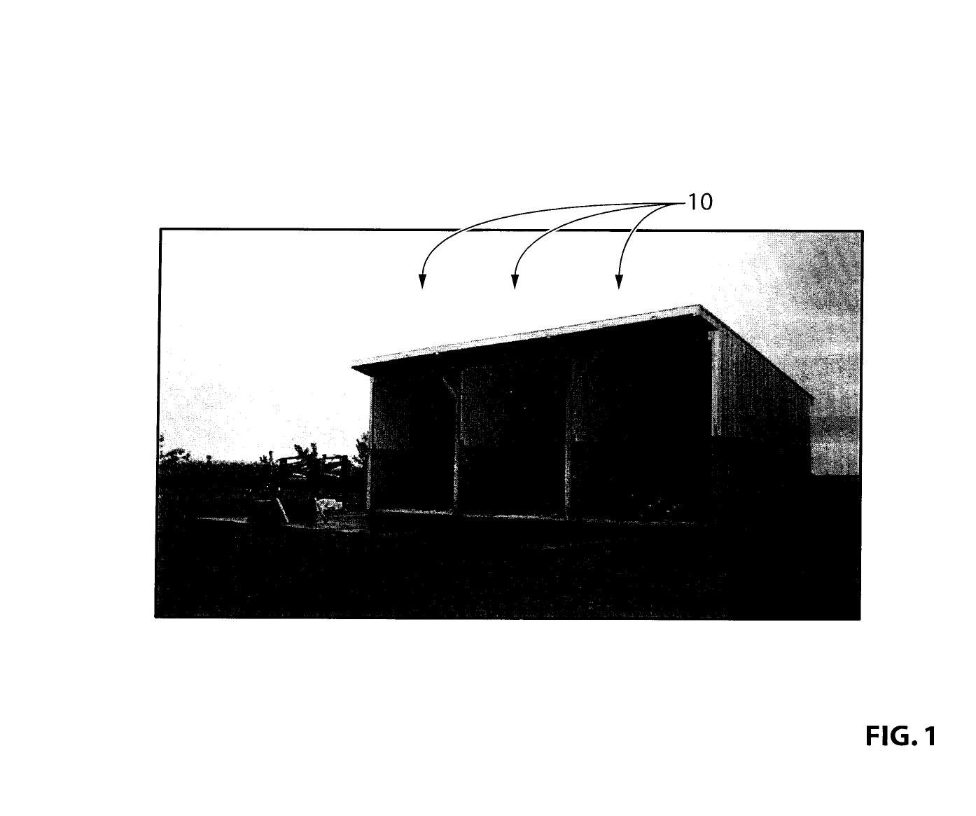

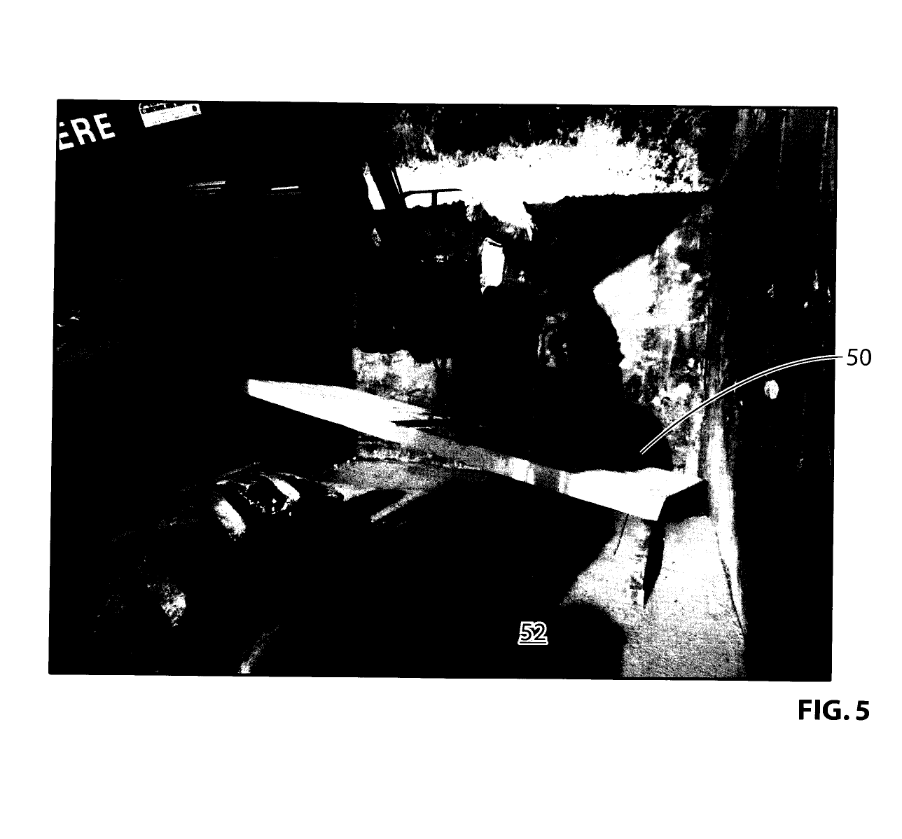

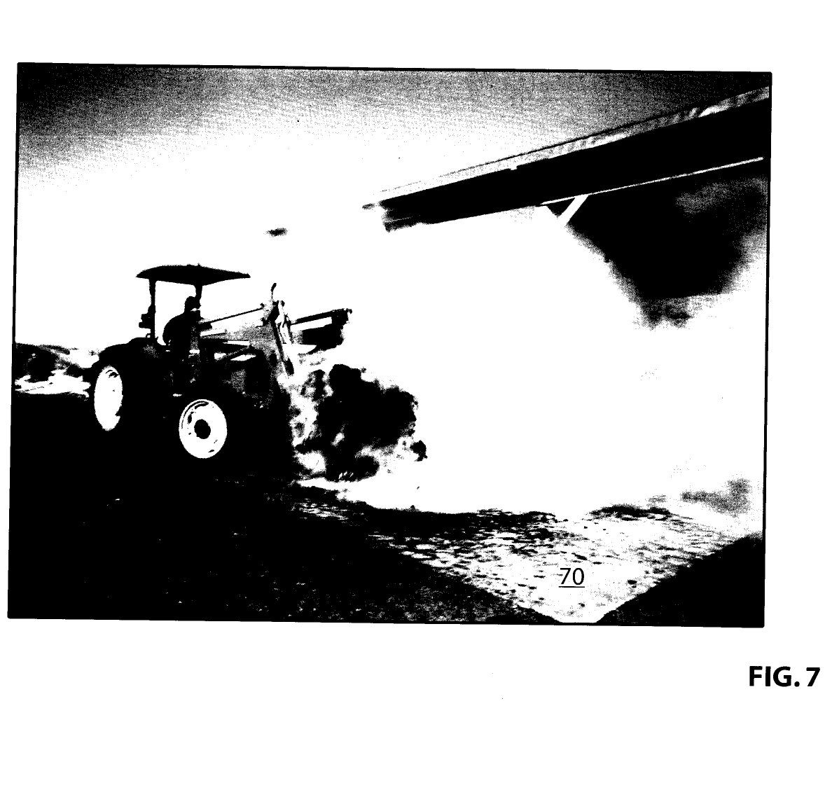

The method of the present invention may be performed in any suitable platform as a base to be modified to perform the method of the present invention. Existing similar composting platform could also be used if equipped with the necessary ventilation, draining and reservoirs, if adequately modified. Preferably, the method of the present invention may be performed in compositing compartments 10 that all comprise a leachate retaining base 52 (See FIG. 5) that prevents the leachate from draining or filtering into the surrounding soil. Also, the plateform may also be connected to an attendant reservoir 30 for collecting the leachate, such as a tank, or an artificial basin. As discussed above, the leachate is reinjected into the composting mixture from the reservoir 30. In certain cases, the volume of leachate available may reach excess levels (e.g. the reservoirs become full) and the excess leachate may be drained therefrom to be disposed in an environmentally friendly fashion, such as transporting it to a water treatment plant. Preferred composting compartment 10 according to the present invention are illustrated in FIG. 1. The base may take any suitable form that will prevent the liquid from draining in the soil, for example it may be a plastic container or a concrete slab incorporated at the bottom of the composting compartment 10. Preferably, the composting compartments 10 may also be covered by a roof or a cover so as to prevent rain water from entering the composting mixture. Doors are not essential, but they may favor a better evaporation during the winter season. The composting compartment 10 may also include a housekeeping pad 70 (See FIG. 7) to be used as a reception area for new arrivals of compostable organic waste matter. According to another embodiment, the composting compartment 10 could be raised such that the new arrivals of compostable organic waste matter would be directly deposited inside the composting compartment 10. According to another embodiment, such a raised composting compartment 10 would nevertheless comprise a housekeeping pad 70 to prevent spills between other adjacent composting compartments 10 and allow the transfer of the composting mixture from one compartment to another in a safe manner. Use of a composting compartment 10 eliminates the need of traditionally using the growing fields, especially during cold seasons. The volume of the platform used for composting may be any available volume. Their number may also be any number required for the type and size of composting activity being performed. Typically, a composting compartment 10 is able to receive a maximum of 150 m³ of compostable organic waste matter. Three compartments 10 are usually built one next to the other, so that the first may be used as an initial composting compartment 10. The second may be used as a composting compartment 10 when the first compartment 10 is full. The third compartment 10 may be used as storage space for the excess structuring agent that will be used when additional compostable organic waste matter is introduced. The third compartment 10 may also be used as a maturating compartment for receiving parts of the composting matter. Any structuring agent is removed therefrom when maturation of the composting mixture into compost is required. It is critical that the composting mixture be isolated in a distinct, separate and isolated compartment from the new compostable organic waste matter for maturation. The mixing of additional compostable organic waste matter of step may be performed usually once a week. According to an embodiment of the present invention, new compostable waste matter may be introduced on a weekly basis to benefit from the absorbing capacity of the active composting mixture (the mixture being biodegraded). The active composting mixture acts as an inoculant that causes a rapid rise in temperature within the composting mixture, which is essential for the optimization of the evaporation process. Less than 48 hours following the addition of new compostable waste matter temperature from about 60° C. to about 72° C. are easily reached within the composting mixture.

The present invention also relates to a method of biological valorization of compostable organic waste matter in an integrated manner. The integration of the method of the present invention is made by an integrator. The role of the integrator is to implement, integrate and supervise every aspect of the method of the present invention from the start, and maintain it in a continuous manner. The integrator is a persistent presence in all the aspects and steps of the present invention with respect to, for example, following up on the parties involved in the process, quality control, logistics, coordination, and observance of collections or deliveries, respect of contractual obligations, payments, and/or regulatory obligations, etc. The integrator may be, without limitations, an individual, or group of individuals, an organization, a not for profit organization, a company, such as waste management company, a hauling company, a waste collecting and/or recycling company, an environmental company, or any company that may be involved in the valorization of compostable organic waste. The method of the present invention comprises reliable and controlled logistics, with centralization of all operations, for maintaining environmentally secure processes. The integrated method involves the creation by the integrator of a composting cell formed of several waste matter generators, matched with a composting site. According to one embodiment of the present invention, training is provided, supervised, or approved by the integrator to both the waste matter generator(s) and the composting site(s) for performing their respective role in the method of the present invention. According to another embodiment, the integrator exerts a continuous control of the quality of the organic waste matter at the level of the waste matter generator(s) and the composting site(s) such that the organic waste matter that is collected is and remains of the highest possible quality. The method involves collecting in a coordinated manner compostable organic waste matter from one or more waste matter generator. The collections are coordinated by the integrator with each waste matter generator. The number of waste matter generator taking part in a cell will vary according to regions, and may include as few as a single waste matter generator, and include as many as 25 or more waste matter generators. Typical waste matter generator include grocery stores, indoor or outdoor markets, sites of food preparation and/or transformation such as industrial bakeries, and agrifood factories that are generating important quantities of compostable organic waste matter that they would normally redirect to landfill sites or incinerating sites. The waste matter generator may also be a factory generating compostable organic waste matter. The collected compostable organic waste matter is next delivered in a coordinated manner to one or more composting site. The deliveries are also coordinated by the integrator, with each composting sites. According to one embodiment of the present invention, the composting sites may be farms or nursery that are actively growing plants, and are in need of readily available natural fertilizer such as compost in important quantities. Composting sites may also be any suitable site where composting may be performed and/or where appropriate composting compartments 10 may be built.

The collection and delivery of the compostable organic waste matter is done in a coordinated manner according to a predetermined schedule (usually, but not exclusively once weekly, depending on the needs of the waste matter generator), as well as a predetermined geographical route between the waste matter generator and the composting site. The integrator is responsible for the preparation and coordination of the predetermined schedules and predetermined geographical route, as well as for ensuring that both are observed. Although the geographical route used during the transportation of the compostable organic waste matter will be influenced by the density of available waste matter generator and composting sites, as well as their relative proximity to one another, the coordination of the collection and delivery is made so as to maximize the number of collection within the given geographical location of each waste matter generator, and also maximize the number of delivery within the given location of the composting sites. As indicated above, although the distance between each type of sites will be influenced by their relative density and location, according to the present invention, the compostable organic waste matter should not be transported between very distant sites in order to minimize the environmental footprint caused by their transport. Furthermore, prior to transport of the compostable organic waste matter, the transport equipment (e.g. trucks) are rigorously inspected to guarantee that no trash or contaminants remain in the transport equipment (e.g. from previous transport routes) to contaminate and destroy the value of the compostable organic waste matter collected at the waste matter generator. The integrator is responsible for organization of inspections to prevent contaminants from entering the compostable organic matter. The integration of waste matter generators and composting sites allow for a large degree of control over the quality of the composting activity, which allows the integrator to guarantee the very high quality of the organic waste matter for composting. This integration allows for the traceability of the compostable waste matter from its source, and then to rapidly identify, for example, the source of any contamination occurring to one or more specific waste matter generators where, for example, sorting practices would not be properly followed. The integrator is responsible for identifying and correcting deficient sorting practices, and generally ensuring that sorting practices are observed. According to one embodiment, the integrator is a relay between the composting site and the waste matter generator for the correcting deficiencies in the organic waste matter. According to one embodiment, the integrator may be in contact with an employee of each waste matter generator assigned to participate in the method of the present invention (e.g. a project manager). Each of such project manager represent in communication link between the integrator and the waste matter generators, contribute to the control of the quality of the organic waste matter, and are in charge of corrective actions when deficiencies are identified.

Importantly, the method of the present invention also includes that the compostable organic waste matter is sorted on source (SOS). The compostable organic waste matter is sorted away from the non-compostable waste matter before being collected, such that unwanted materials do not end up at the site of composting. Such non-compostable waste matter includes but is not limited to elastic bands, product wrapper made from plastic materials, extruded polystyrene foam or similar materials, or any other non-compostable material. Sorting on source is a critical aspect of the method of the present invention as it is necessary to establish and maintain control of the quality of the compostable organic waste matter. Sorting on source of the compostable organic waste matter also allows substantial savings to be made, as sorting of the waste matter between compostable and non-compostable organic waste matter would have to be performed in an external sorting site, which would add cost to the composting operation. Furthermore, compostable organic waste matter not sorted at the source would likely be of inferior quality because of inferior sorting. For example, compostable organic waste matter from waste matter generators according to the present invention could be mixed with domestic waste matter of inferior sorting quality during transport, which would affect the quality of the compostable organic waste matter obtained from such sorting sites.

The employees and the waste matter generator are often initially ill equipped for performing the sorting task. For example, the waste matter generators are often not aware of what constitutes compostable waste matter versus non-compostable waste matter, and no designated equipment exist on site to receive the waste matter. Therefore, the method of the present invention also provides that the integrator provides training to any employee of the waste matter generator involved in the sorting process for sorting of the compostable organic waste matter from the non-compostable waste matter. Furthermore, the integrator provides all waste matter generators with a teaching manual that any untrained employee will read in order to become familiar with the process of the present invention. According to one embodiment, following this reading, the employee may be formally trained by the integrator if necessary. According to another embodiment, adequate equipment may be installed for sorting of compostable organic waste matter from said non-compostable waste matter. According to another embodiment, the integrator may include visual information (e.g. pictograms) in the site where sorting is performed for reminding employees of the adequate sorting practices. Sorting on site by employees of the waste matter generator allows for the production of very high quality compostable organic waste matter that will eventually produce compost of extremely high quality.

The method of the present invention also includes that the compostable organic waste matter may be weighed concurrently during the collection step. This step is important in order to determine the cost associated with the disposal of the compostable organic waste matter. Furthermore, it is sometimes possible to evaluate the volume of compostable organic waste matter of some waste matter generator based on their revenues and their operations. The measured weight of organic waster matter is recorded and transmitted to the integrator, for example for billing purposes, performance statistics and technical data collection.

The method of the present invention may also include that prior to a delivery of compostable organic waste matter to the composting site, a composting bed is prepared in a composting compartment 10 at the composting site. The composting bed is prepared on a sealed structure (e.g. the leachate retaining base 52 and/or the housekeeping pad 70), because at the delivery of the compostable organic waste matter, the quantity of liquid is large. Deposition of the compostable organic waste matter directly on the ground would immediately result in contamination. The composting bed retains the leachate on the sealed structure and allows rapid absorption of the liquid into the composting mixture. According to another embodiment of the present invention, the organic waste matter may also be directly deposited into the composting compartment. The leachate that may not be readily absorbed in the composting mixture is drained off to the attendant reservoir(s) 30. During the first delivery of compostable organic waste matter, the first bed prepared will be entirely composed of structuring agent. The preparation of the composting bed during subsequent delivery of compostable organic waste matter may include mixing and distributing the composting mixture already present within the composting compartment 10 over the area of the composting compartment 10, or if required, between one or more other composting compartments 10. Following the arrival of new organic waste matter at the composting site, the composting mixture is mixed in order to integrate the new organic waste matter therein. Preferably, mixing is done within 6 hours of the arrival of the new organic waste matter. The method of the present invention includes for the training of employees of the composting site by the integrator for performing the integrated method of composting of the present invention. Furthermore, the integrator provides all composting sites with a teaching manual that any untrained employee will read in order to become familiar with the process of the present invention. According to one embodiment, following this reading, the employee may be formally trained by the integrator if necessary. The integrator also controls that the compostable organic waste matter is exclusively from approved waste matter generator, and forbids additions of organic waste matter from sources not controlled by the integrator. The method of the present invention also includes for the construction or the modification of existing equipment for the composting of compostable organic waste matter according to the method of the present invention.

The method of the present invention also includes the integrated method of composting compostable organic waste matter described above. Once the compostable organic waste matter has been delivered to the composting site, it is composted by macerating the composting mixture of compostable organic waste matter with the structuring agent in the composting compartment 10 for a period of time sufficient for endogenous microorganisms to effect biodegradation. Subsequent deliveries of compostable organic waste matter ensure that the composting mixture is mixed with additional compostable organic waste matter and/or structuring agent. When the composting compartment 10 is full, or when there is a need for compost for fertilization, part of the composting mixture is transferred to a maturation compartment from the initial composting compartment to further mature and produce a compost for use as a fertilizer (FIG. 1). The isolated composting mixture is isolated to from the initial composting mixture so as to allow maturation and promote the biosecurity of the composting process. As described above, the composting compartment 10 comprises a leachate retaining base 52 that prevents draining of the leachate into a surrounding soil.

The composting method of the present invention may be performed over a period of minimum 12 weeks. The method may be performed over longer or even shorter periods of time, taking in consideration the needs in fertilizer, as well as the space available for composting. After the beginning of the composting activity, frequent quality control visits are performed at the composting site to verify that the activities are well performed by the integrator. Similar quality control visits are also performed at the waste matter generators by the integrator. Monthly visits are also made, unannounced, to the composting site, to verify the quality of the compost being produced. According to one embodiment, the integrator will also provide technical support for starting and maintaining the composting operation of the operator of the composting site. Log books and data sheets containing information concerning the deliveries of compostable organic waste matter received are maintained by the composting site operator to provide information concerning the amounts of organic waste matter received and where they originated from, the structuring agent introduced in the mixture, the technical data (temperature, ventilator pressure, etc). With the help of this information, the integrator may provide technical support to troubleshoot deficient composting.

### Alternative Embodiments

### Example I

### Exemplary Management of Compostable Organic Waste Matter

Compostable organic waste matter is sorted by site's employees at different nearby grocery stores (waste matter generators). Elastic bands and plastic product wrappers are recycled, while fruits, vegetables, bakery products (mostly bread) pass their due dates, and product containers made from waxed cardboards are deposited in appropriately labeled bins. Waxed carboard boxes are cut, torn or shredded. Weekly, on the same day, a waste disposal truck visited all sites, weighed and collected the products. The weight of the compostable organic waste matter is recorded for later invoicing of the waste matter generator for waste disposal, as well as collection of any carbon tax credit available for composting of the waste matter.

The compostable organic waste matter is transported on the same day to one site of composting. The site of composting has previously been equipped with (or existing equipment modified) appropriate composting infrastructure, where the previously prepared composting mixture is been arranged into suitable composting beds adapted to receive the new compostable organic waste matter. The composting mixture is then mixed and allowed to macerate and mature.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

1.-17. (canceled)

18. An integrated method of biological valorization of compostable organic waste matter for composting comprising:
a) collecting in a coordinated manner a compostable organic waste matter from at least one waste matter generator, wherein waste matter is transformed into high quality compostable organic waste matter by sorting said compostable organic waste matter from a non-compostable waste matter; and
b) delivering in a coordinated manner said collected compostable organic waste matter to at least one composting site;
wherein said coordinated manner is based on a schedule and a geographical route between said waste matter generator and said composting site; and
wherein quality of said compostable organic waste matter is verified at the waste matter generator and at the composting site to prevent contamination of said organic waste matter with a non-compostable waste matter.

19. The method as claimed in claim 18, further comprising in step a) or in step b) weighing said compostable organic waste matter concurrently to said collecting or delivering.

20.-21. (canceled)

22. The method as claimed in claim 18, wherein said sorting is performed by said waste matter generator.

23. The method as claimed in claim 18, further comprising providing training to an employee of the waste matter generator for sorting of said compostable organic waste matter from said non-compostable waste matter.

24. The method as claimed in claim 18, further comprising providing an equipment for sorting of compostable organic waste matter from said non-compostable waste matter.

25. The method as claimed in claim 18, further comprising preparing composting bed in a composting compartment at said composting site prior to delivery of said compostable organic waste matter to said composting site.

26. The method as claimed in 18, wherein said organic waste matter is delivered directly into a composting compartment at said composting site.

27. The method as claimed in claim 18, further comprising composting said compostable organic waste matter delivered at the composting site by
a) macerating a composting mixture of compostable organic waste matter with a structuring agent in a composting compartment for a period of time sufficient for endogenous microorganisms to effect biodegradation; and
b) mixing additional compostable organic waste matter and/or structuring agent in the composting mixture of step ca), wherein when said composting compartment is full, at least part of said composting mixture is transferred to a maturation compartment to further macerate and produce a compost for use as a fertilizer,
wherein said composting compartment comprises a leachate retaining base preventing draining of leachate into a surrounding soil, and is connected to a reservoir for collecting said leachate,
wherein said leachate is reinjected into said composting mixture and said composting mixture is exposed to an evaporator to evaporate said leachate from said composting mixture.

28.-31. (canceled)

32. The method according to claim 27, wherein said leachate is reinjected when said composting mixture has reached a temperature from about 60° C. to 72° C.

33. The method according to claim 27, wherein said leachate is reinjected when said composting mixture has reached a density from about 650 g/L to about 750 g/L.

34. The method as claimed in claim 27, wherein the ratio of the volume of organic waste matter to the volume of structuring agent is from about 1.5:1 to about 3:1, or from about 2:1.5 to about 3:1.5.

35. The method as claimed in claim 27, wherein said compostable organic waste matter or said structuring agent in step a) is from about 43% to about 57% of the total initial volume of the composting mixture.

36. (canceled)

37. The method as claimed in claim 27, wherein when additional compostable organic waste matter and structuring agent is added in said composting mixture of step a), the ratio of said compostable organic waste matter to said structuring agent is from about 3.0:1 to about 6:1.

38. (canceled)

39. The method as claimed in claim 18, further comprising providing training to an employee of the composting site for performing a method of composting.

40. The method as claimed in claim 18, wherein said compostable organic waste matter comprises food waste, vegetal matter, vegetable matter, fruit matter, bakery matter, or combinations thereof.

41. (canceled)

42. The method as claimed in claim 18, wherein said structuring agent comprises sawdust, straw, peat, grass, jute, cardboard, corn cob granules, bark chips, woodchips, wood particles, manure or combinations thereof.

43. The method as claimed in claim 18, wherein said leachate retaining base is made from concrete, a plastic polymer, or combinations thereof.

44. (canceled)

45. (canceled)

46. The method as claimed in claim 18, further comprising visiting said waste matter generator for controlling the quality of said compostable organic waste matter.

47. The method as claimed in claim 18, further comprising visiting said composting site for controlling the quality of said composting mixture.

48. (canceled)

49. The method as claimed in claim 18, further comprising collection of a carbon tax credit by an integrator.
